(19) United States
(12) Patent Application Publication
(10) Pub. No.: US 2026/0158480 A1
(43) Pub. Date: Jun. 11, 2026

(54) Catalysts for Olefin Metathesis, Methods of Preparation, and Processes for the Use Thereof

(71) Applicant: ExxonMobil Chemical Patents Inc., Baytown, TX (US)

(72) Inventors: Gursu Culcu, Humble, TX (US); Alexander V. Zabula, Seabrook, TX (US); Alan A. Galuska, Huffman, TX (US); David A. Cano, Houston, TX (US)

(21) Appl. No.: 19/179,749

(22) Filed: Apr. 15, 2025

Related U.S. Application Data
(62) Division of application No. 17/767,369, now abandoned.
(60) Provisional application No. 62/914,222, filed on Oct. 11, 2019.

(30) Foreign Application Priority Data
Mar. 20, 2020 (EP) 20164532.2

(51) Int. Cl. B01J 31/12

(52) U.S. Cl. CPC B01J 31/122; B01J 2231/12; B01J 2231/54; B01J 2531/66

(57) ABSTRACT

The present disclosure relates to tungsten complexes, catalyst systems including tungsten complexes, and polymerization processes to produce polycycloolefin polymers such as polycyclopentene polymers and polycyclooctene polymers.

### PRIORITY

This application claims priority to and the benefit of U.S. Provisional Application No. 62/914,222, filed Oct. 11, 2019, and EP 20164532.2 filed Mar. 20, 2020, the disclosures of which are incorporated herein by reference.

### CROSS REFERENCE TO RELATED APPLICATIONS

This application is related to PCT Application PCT/US2020/______, filed concurrently herewith, having Attorney Docket No. 2019EM409-PCT, and entitled “Catalysts for Olefin Metathesis, Methods of Preparation, and Processes for the Use Thereof,” which claims priority to U.S. Ser. No. 62/914,197, filed Oct. 11, 2019, which are incorporated by reference herein.

This application is related to application U.S. Ser. No. ______, filed concurrently herewith having Attorney Docket No. 2019EM417-US2 and entitled “Indacene Based Metallocene Catalysts Useful in the Production of Propylene Polymers,” which claims priority to U.S. Ser. No. 62/914,209, filed Oct. 11, 2019, which are incorporated by reference herein.

This application is related to application U.S. Ser. No. ______, filed concurrently herewith having Attorney Docket No. 2019EM419-US2 and entitled “Catalysts for Olefin Polymerization,” which claims priority to U.S. Ser. No. 62/914,262, filed Oct. 11, 2019, which are incorporated by reference herein.

### FIELD

The present disclosure provides catalyst compounds including tungsten metal complexes, production, and use thereof.

### BACKGROUND

Metathesis catalysts are of great use in industry and polymer products formed by Ring Opening Metathesis Polymerization (ROMP) are widely used commercially because of their robust physical properties. Hence, there is interest in finding new catalysts that increase commercialization of the catalysts and allow the production of polymers having improved properties.

Since its discovery in the 1950s, olefin metathesis has emerged as a valuable synthetic method for the formation of carbon-carbon double bonds (olefins). The recent advances in olefin metathesis applications in organic syntheses and polymer syntheses rely on developments of well-defined catalysts. The diversity of possible applications has led to the use of olefin metathesis as a standard synthetic tool. Olefin metathesis applications include cross-metathesis, ring-opening metathesis polymerization, ring-opening cross metathesis, ring-closing metathesis, and acyclic diene metathesis. An industrially important application is production of polymers produced from ROMP including polyalkenamers, such as polyoctenamer (polymer of cyclooctene) or polypentenamer (polymer of cyclopentene). Metathesis reactions are therefore indispensable as a synthetic tool for the formation of new carbon-carbon bonds.

Olefin metathesis may be catalyzed by one or more catalytic metals, usually one or more transition metals, such as the molybdenum-containing Schrock catalyst and the ruthenium- or osmium-containing Grubbs catalysts. Single component ruthenium or osmium catalysts have been previously described by, for example, U.S. Pat. Nos. 5,312,940; 5,342,909; 5,728,917; 5,710,298; 5,750,815; 5,831,108; 7,329,758; and PCT Publications WO 1997/020865 and WO 1997/029135. These catalysts possess several advantageous properties, such as tolerance to a variety of functional groups and high activity.

On the other hand, improvements in metathesis catalysis including ROMP catalysis, may arise from catalysts capable of producing polycycloolefins with: high molecular weights, controllable molecular weights, or narrow polydispersity indices. Polycycloolefins, which have high molecular weight, typically have desirable mechanical properties over their lower molecular weight counterparts. A catalyst capable of one or more of the aforementioned improvements is valuable, but even more so if a catalyst combines a number of improvements into an overall advantage over prior catalysts or catalyst systems. The catalyst activity and polymer properties may be affected by the solubility of the catalyst in the reaction medium. The reaction medium may not include solvent other than the reactants and may include aliphatic hydrocarbon(s). Many previous metathesis catalysts are only sparingly soluble in aliphatic hydrocarbon and may, therefore, be limited in application and production of certain polycycloolefin products.

Furthermore, polycycloolefins, such as polypentenamer, may have a comonomer, such as cyclooctene, incorporated into the polypentenamer backbone. These copolymers provide varying physical properties compared to polypentenamer homopolymers and may be produced in a low pressure reactor, utilizing, for example, solution, slurry, or gas phase polymerization processes. The comonomer content of a polycycloolefin (e.g., wt % of comonomer incorporated into a polycycloolefin backbone) influences the properties of the polycycloolefin (and composition of the copolymers) and is influenced by the polymerization catalyst.

There remains a need for catalysts soluble in aliphatic hydrocarbons which are capable of being synthesized by mild, affordable, and simple synthetic routes and which demonstrate selectivity in metathesis transformations including high cis-double bond formation. Furthermore, there is a need for new and improved catalyst compounds and catalyst systems for polycycloolefin polymerization that produce polycycloolefins with certain properties, such as controllable molecular weights, including high molecular weights, high melting point, high comonomer incorporation, or narrow polydispersity index.

References for citing in an information disclosure statement (37 C.F.R. 1.97(h)): U.S. Pat. Nos. 3,634,376; 3,719,652; 4,391,737; 4,426,502; 4,696,985; 4,882,401; 4,981,931; 5,066,740; 5,019,544; 5,034,482; 5,194,534; 5,198,511; 5,278,305; 5,391,658; 5,606,085; 5,639,900; 6,433,113; 6,973,949; 7,737,233; 7,956,132; 8,889,786; 9,085,595; 9,441,059; 9,919,299; 10,071,950; US Publication Nos. 2007/0208206; 2014/0309388; 2016/0002382; 2017/0129990; 2018/0244837; 2019/0009260; PCT Publications WO 2005/082819.
Rosenfeld, D. C. et al. (2006) “Synthesis and Reactivity of (silox)₂R₂WO (R═Cl, Me, Et, ⁿPr and ⁿBu; silox=OSi^{t}Bu₃) and (silox)₂MO₂ (M=Mo and W), Polyhedron, v.25(2), pp. 251-258.
Kuiper, D. S. et al. (2008) “Four-Coordinate Mo(II) as (silox)₂Mo(PMe₃)₂ and Its W(IV) Congener (silox)₂HW(h₂-CH₂PMe₂)(PMe₃) (silox=tBu₃SiO),” Inorganic Chemistry, v.47(22), pp. 10542-10553.
Kuiper, D. S. et al. (2008) “Molybdenum and tungsten structural differences are dependent on ndz2/(n+1)s mixing: comparisons of (silox)₃MX/R (M=Mo, W; silox=tBu₃SiO),” Inorganic Chemistry, v.47(16), pp. 7139-7153.
Veige, A. S. et al. (2003) “Symmetry and Geometry Considerations of Atom Transfer: Deoxygenation of (silox)₃WNO and R₃PO (R=Me, Ph, tBu) by (silox)₃M (M=V, NbL (L=PMe₃, 4-Picoline), Ta; silox=tBu₃SiO),” Inorganic Chemistry, v.42(20), pp. 6204-6224.
Chamberlain, R. L. M. et al. (2002) “Ethylene and Alkyne Carbon-Carbon Bond Cleavage across Tungsten-Tungsten Multiple Bonds,” Organometallics, v.21(13), pp. 2724-2735.
Miller, R. L. et al. (1996) “Ditungsten Siloxide Hydrides, [(silox)₂WHn]₂ (n=1, 2; silox=tBu₃SiO), and Related Complexes,” Inorganic Chemistry, v.35(11), pp. 3242-3253.
Miller. R. L. et al. (1993) “Carbide Formation via Carbon Monoxide Dissociation across a Tungsten-Tungsten Triple Bond,” J. Am. Chem. Soc., v.115(22), pp. 10422-10423.
Eppley, D. F. et al. (1991) “A Complex with Three-Coordinated Tungsten Atom: [(silox)₂W-NtBu](silox=tBu₃SiO),” Angewandte Chemie, v.30(5), pp. 584-585.
Herz, K. et al. (2013) “Functional ROMP-Derived Poly(cyclopentene)s,” Macromol. Chem. Phys., v.214(13), pp. 1522-1527.
Chan, K. W. et al. (2018) “C—H Activation and Proton Transfer Initiate Alkene Metathesis Activity of the Tungsten(IV)-Oxo Complex,” J. Am. Chem. Soc., v.140(36), pp. 11395-11401.
Auntenrieth, B. et al. (2015) “Stereospecific Ring-Opening Metathesis Polymerization (ROMP) of Norbornene and Tetracyclododecene by Mo and W Initiators,” Macromolecules, v.48(8), pp. 2493-2503.
Nakayama, Y. et al. (1997) “Cis-Specific Polymerization of Norbornene Catalyzed by Tungsten Based Complex Catalysts Bearing an O—N—O Tridentate Ligand,” Chemistry Letters, v.26(9), pp. 861-862.
Tucker, H. et al. (1975) “Structure and Properties of Polypentenamer,” Polymer Engineering & Science, v.15(5), pp. 360-366.
Haas, F. et al. (1970) “Properties of a Trans-1,5-Polypentenamer Produced by Polymerization through Ring Cleavage of Cyclopentene,” Rubber Chem. Technol., v.43(5), pp. 1116-1128.
Natta, G. et al. (1964) “Stereospecific Homopolymerization of Cyclopentene,” Angewandte Chemie International Ed., v.3(11), pp. 723-729.
Liu, P. et al. (2018) “Olefin Metathesis Reaction in Rubber Chemistry and Industry and Beyond,” Ind. & Eng. Chem. Res., v.57(11), pp. 3807-3820.
Mugemana, C. et al. (2016) “Ring Opening Metathesis Polymerization of Cyclopentene Using a Ruthenium Catalyst Confined by a Branched Polymer Architecture,” Polymer Chemistry, v.7(17), pp. 2923-2928.
Mulhearn, W. D. et al. (2017) “Synthesis of Narrow-Distribution, High-Molecular-Weight ROMP Polycyclopentene via Suppression of Acyclic Metathesis Side Reactions,” ACS Macro Letters, v.6(2), pp. 112-116.
Torre, M. et al. (2018) “Ring-Opening Metathesis Copolymerization of Cyclopentene Above and Below Its Equilibrium Monomer Concentration,” Macromol. Chem. Phys., v.219(9), 1800030, 8 pgs.

### SUMMARY

The present disclosure relates to catalyst systems including an activator and a catalyst compound, where the catalyst compound is represented by Formula (I):

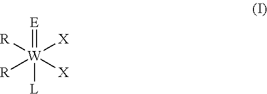

where:
E is O, S, Se, Te, or NR″;
each instance of R is independently is —OR′, —SR′, —OSi(OR′)₃, or —OSiR′₃, provided that when X is Cl, R is not —OR′;
R′ is an unsubstituted hydrocarbyl or a substituted hydrocarbyl;
R″ is a hydrocarbyl or substituted hydrocarbyl, a heteroatom or a heteroatom-containing group;
each X is a halogen, C₁ to C₁₀ hydrocarbyl, or a substituted C₁ to C₁₀ hydrocarbyl; and L is Lewis base.

In yet another embodiment, the present disclosure provides a process for the production of a polycycloolefin including polymerizing a cycloolefin by introducing the cycloolefin with a catalyst system of the present disclosure in at least one polymerization reactor at a reactor pressure of from 2 MPa to 200 MPa and a reactor temperature of from about 10° C. to about 250° C. to form a polycycloolefin.

In still another embodiment, the present disclosure provides for a catalyst compound represented by Formula (II):

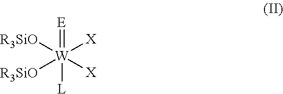

where:
E is O, S, Te, Se, or NR″;
each instance of R is independently a hydrocarbyl or substituted hydrocarbyl, a heteroatom or a heteroatom-containing group, provided that when E is O, R is not tert-butyl or tert-butoxy;
R″ is a hydrocarbyl or substituted hydrocarbyl, a heteroatom or a heteroatom-containing group;
each X is a halogen, C₁ to C₁₀ hydrocarbyl, or a substituted C₁ to C₁₀ hydrocarbyl; and L is Lewis base.

### DETAILED DESCRIPTION

The present disclosure provides catalyst compounds including tungsten oxo and tungsten imido compounds, catalyst systems including such, and uses thereof. In at least one embodiment, the present disclosure is directed to catalyst compounds, catalyst systems, and their use in polymerization processes to produce polycycloolefin polymers, such as polypentenamers. Catalyst compounds of the present disclosure can be tungsten-containing compounds having a silox (tri-tert-butylsilanolate) ligand. In another class of embodiments, the present disclosure is directed to polymerization processes to produce polyolefin polymers from catalyst systems including one or more olefin polymerization catalysts, at least one activator, and an optional support.

For example, the present disclosure provides polymerization processes to produce a polypentenamer, the process including introducing a catalyst system including one or more tungsten catalyst compounds, at least one activator, and an optional support, to cyclopentene and one or more C₄-C₁₂ cycloolefin comonomers under polymerization conditions.

Catalysts systems, and processes of the present disclosure may be soluble in aliphatic hydrocarbon and can provide polyolefins with one or more of: high cis-double bond incorporation, high Mn (e.g., 100,000 g/mol or greater), high Mw values of 200,000 g/mol or greater, and narrow PDI (e.g., about 3 or less). The catalyst systems, and processes of the present disclosure may provide one or more of the aforementioned advantages at temperature higher than previous processes, including RT and higher, removing the need for expensive reactor cooling processes and reducing costs of production.

### Definitions

For the purposes of the present disclosure and the claims thereto, the new numbering scheme for the Periodic Table Groups is used as described in Chemical and Engineering News, v.63(5), pg. 27 (1985). Therefore, a “group 6 metal” is an element from group 6 of the Periodic Table, e.g. Cr, Mo, or W.

“Conversion” is the amount of monomer that is converted to polymer product, and is reported as mol % and is calculated based on the polymer yield and the amount of monomer fed into the reactor.

The term “ring-opening metathesis polymerization” includes polymerizing a cycloolefin monomer. Monomers may include strained cycloalkenes, such as cyclopentene or cyclooctene. The polymer formed has a plurality of carbon-carbon double bonds along the polymer backbone.

An “olefin,” alternatively referred to as “alkene,” is a linear, branched, or cyclic compound of carbon and hydrogen having at least one double bond. For purposes of this specification and the claims appended thereto, when a polymer or copolymer is referred to as including an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, includes terpolymers. “Different” as used to refer to mer units indicates that the mer units differ from each other by at least one atom or are different isomerically. An “ethylene polymer” or “ethylene copolymer” is a polymer or copolymer including at least 50 mole % ethylene derived units, a “propylene polymer” or “propylene copolymer” is a polymer or copolymer including at least 50 mole % propylene derived units, and so on.

The term “Cn” means hydrocarbon(s) having n carbon atom(s) per molecule, where n is a positive integer, unless otherwise specified. The term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n. Likewise, a “Cₘ-C_{y}” group or compound refers to a group or compound including carbon atoms at a total number from m to y. Thus, a C₁-C₅₀ alkyl group refers to an alkyl group including carbon atoms at a total number from 1 to 50.

The terms “group,” “radical,” and “substituent” may be used interchangeably.

The terms “hydrocarbyl radical,” “hydrocarbyl group,” or “hydrocarbyl” may be used interchangeably and are defined to mean a group consisting of hydrogen and carbon atoms only. Suitable hydrocarbyls are C₁-C₁₀₀ radicals that may be linear, branched, or cyclic, and when cyclic, aromatic or non-aromatic. Examples of such radicals include alkyl groups, such as methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, or aryl groups, such as phenyl, benzyl, or naphthyl.

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃ where q is 1 to 10 and each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃ where q is 1 to 10 and each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted aromatic,” means an aromatic group having 1 or more hydrogen groups replaced by a hydrocarbyl, substituted hydrocarbyl, heteroatom or heteroatom containing group.

For purposes of the present disclosure, in relation to catalyst compounds, the term “substituted” means that a hydrogen group has been replaced with a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃, where q is 1 to 10 and each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The terms “alkoxy” and “alkoxide” mean an alkyl or aryl group bound to an oxygen atom, such as an alkyl ether or aryl ether group/radical connected to an oxygen atom and can include those where the alkyl/aryl group is a C₁ to C₁₀ hydrocarbyl. The alkyl group may be straight chain, branched, or cyclic. The alkyl group may be saturated or unsaturated. Examples of suitable alkoxy radicals can include methoxy, ethoxy, n-propoxy, iso-propoxy, n-butoxy, iso-butoxy, sec-butoxy, tert-butoxy, or phenoxyl.

The terms “alkyl radical,” and “alkyl” are used interchangeably throughout this disclosure. For purposes of this disclosure, “alkyl radical” is defined to be C₁-C₁₀₀ alkyls, which may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and the like including their substituted analogues. Substituted alkyl radicals are radicals in which at least one hydrogen atom of the alkyl radical has been substituted with at least a non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to 10 and each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “aryl” or “aryl group” means an aromatic ring and the substituted variants thereof, such as phenyl, 2-methyl-phenyl, xylyl, 4-bromo-xylyl. Likewise, heteroaryl means an aryl group where a ring carbon atom (or two or three ring carbon atoms) has been replaced with a heteroatom, such as N, O, or S. The term “aromatic” also refers to pseudoaromatic heterocycles which are heterocyclic substituents that have similar properties and structures (nearly planar) to aromatic heterocyclic ligands, but are not by definition aromatic.

Where isomers of a named alkyl, alkenyl, alkoxide, or aryl group exist (e.g., n-butyl, iso-butyl, sec-butyl, and tert-butyl) reference to one member of the group (e.g., n-butyl) shall expressly disclose the remaining isomers (e.g., iso-butyl, sec-butyl, and tert-butyl) in the family. Likewise, reference to an alkyl, alkenyl, alkoxide, or aryl group without specifying a particular isomer (e.g., butyl) expressly discloses all isomers (e.g., n-butyl, iso-butyl, sec-butyl, and t-butyl).

Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol (g mol⁻¹).

“RT” is room temperature (and is 23° C. unless otherwise indicated).

A “catalyst system” is a combination of at least one catalyst compound, at least one activator, an optional co-activator, and an optional support material. When “catalyst system” is used to describe such a pair before activation, it means the unactivated catalyst complex (precatalyst) together with an activator and, optionally, a co-activator. When “catalyst system” is used to describe such a pair after activation, it means the activated complex and the activator or other charge-balancing moiety. The transition metal compound may be neutral as in a precatalyst, or a charged species with a counter ion as in an activated catalyst system. For the purposes of this present disclosure and the claims thereto, when catalyst systems are described as including neutral stable forms of the components. A polymerization catalyst system is a catalyst system that can polymerize monomers to polymer. Furthermore, catalyst compounds and activators represented by formulae described embrace both neutral and ionic forms of the catalyst compounds and activators.

In this disclosure, the catalyst may be described as a catalyst, a catalyst precursor, a pre-catalyst compound, catalyst compound or a transition metal compound, and these terms are used interchangeably.

A scavenger is a compound that is typically added to facilitate polymerization by scavenging impurities. Some scavengers may also act as activators and may be referred to as co-activators. A co-activator, that is not a scavenger, may also be used in conjunction with an activator in order to form an active catalyst. In at least one embodiment a co-activator can be pre-mixed with the transition metal compound to form an alkylated transition metal compound.

The term “continuous” means a system that operates without interruption or cessation. For example a continuous process to produce a polymer would be one where the reactants are continually introduced into one or more reactors and polymer product is continually withdrawn.

A solution polymerization means a polymerization process in which the polymer is dissolved in a liquid polymerization medium, such as an inert solvent or monomer(s) or their blends. A solution polymerization is typically homogeneous. A homogeneous polymerization is one where the polymer product is dissolved in the polymerization medium. In at least one embodiment, such systems are not turbid as described in Oliveira, J. V. et al. (2000) Ind. Eng. Chem. Res., v.39, pg. 4627.

A bulk polymerization means a polymerization process in which the monomers and/or comonomers being polymerized are used as a solvent or diluent using little or no inert solvent as a solvent or diluent. A small fraction of inert solvent might be used as a carrier for catalyst and scavenger. A bulk polymerization system contains less than 25 wt % of inert solvent or diluent, such as less than 10 wt %, such as less than 1 wt %, such as 0 wt %.

A “Lewis base” is a neutrally charged ligand which donates one or more pairs of electrons to a metal ion. Examples of Lewis bases include ethylether, trimethylamine, pyridine, tetrahydrofuran, dimethylsulfide, and triphenylphosphine. The term “heterocyclic Lewis base” refers to Lewis bases that are also heterocycles. Examples of heterocyclic Lewis bases include pyridine, imidazole, thiazole, and furan. The bis(aryl phenolate) Lewis base ligands are tridentate ligands that bind to the metal via two anionic donors (phenolates) and one heterocyclic Lewis base donor (e.g., pyridinyl group). The bis(aryl phenolate)heterocycle ligands are tridentate ligands that bind to the metal via two anionic donors (phenolates) and one heterocyclic Lewis base donor.

### Catalyst Compounds

The present disclosure relates to a tungsten catalyst compounds having at least an oxygen or sulfur containing R group, two halogens, and a Lewis base.

The present disclosure is related to catalyst compounds, and catalyst systems including such compounds, represented by the Formula (I):

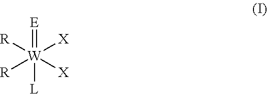

where:
E is O, S, Se, Te, or NR″;
R is independently a —OR′, —SR′, —OSi(OR′)₃, or —OSiR′₃, provided that when X is Cl, R is not —OR′;
R′ is independently an unsubstituted hydrocarbyl or a halogen substituted hydrocarbyl;
R″ is an unsubstituted hydrocarbyl, substituted hydrocarbyl, a heteroatom, or a heteroatom-containing group (such as O, N, P, S), or a combination thereof;
each X is a halogen, C₁ to C₁₀ hydrocarbyl, or a substituted C₁ to C₁₀ hydrocarbyl; and L is Lewis base.

In some embodiments, both X groups are the same. In some embodiments, each X group is different.

In some embodiments, E is O, S, or NR″. In some embodiments, E is O or NR″.

In some embodiments, X is F, Cl, Br, or I, such as X is Cl.

In some embodiments, R is independently —OSi(OR′)₃ or —OSiR′₃. In some embodiments, R′ is independently a tert-butyl, trifluoromethyl, 1,1-di(trifluoromethyl)ethyl, or I-methyl-1-(trifluoromethyl)ethyl. In some embodiments, R is —OSi(OR′)₃ or —OSiR′₃ and R′ is a tert-butyl, trifluoromethyl, 1,1-di(trifluoromethyl)ethyl, or 1-methyl-1-(trifluoromethyl)ethyl. In some embodiments, R is —OSi(OR′)₃ and R′ is tert-butyl.

In some embodiments, R″ is substituted or unsubstituted alkyl or aryl, such as a linear or branched C₁-C₁₀ alkyl, a C₆-C₄₀ substituted aromatic, or a C₆-C₄₀ unsubstituted aromatic. In some embodiments, R″ is tert-butyl, phenyl, 2,4,6-trimethylphenyl, or 2,6-di-t-butyl-4-methylphenyl, such as tert-butyl.

In some embodiments, L is an amine, an ether, a thioether, or a phosphine. In some embodiments, L is selected from substituted or unsubstituted: pyridine, diethyl ether, tetrahydrofuran, furan, thiofuran, or pyrrole. In some embodiments, L is selected from substituted or unsubstituted: pyridine or pyrrole. In some embodiments, L is selected from: pyridine or N-methylpyrrolidone, such as pyridine. In other embodiments, L is a substituted pyridine, such as 2,6-dimethylpyridine, 2,4,6-trimethylpyridine, N,N-dimethyl-4-aminopyridine.

In some embodiments, a catalyst compound may be represented by Formula (II):

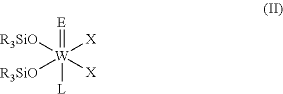

where:
E is O, S, Te, Se, or NR″;
each instance of R is independently a hydrocarbyl or substituted hydrocarbyl, a heteroatom or a heteroatom-containing group, provided that when E is O, R is not tert-butyl or tert-butoxy;
R″ is a hydrocarbyl or substituted hydrocarbyl, a heteroatom or a heteroatom-containing group;
each X is a halogen, C₁ to C₁₀ hydrocarbyl, or a substituted C₁ to C₁₀ hydrocarbyl; and L is Lewis base.

In one or more embodiments, a 20 wt % mixture of the catalyst compound in n-hexane, isohexane, cyclohexane, methylcyclohexane, or a combination thereof, forms a clear homogeneous solution at 25° C. In some embodiments, a 30 wt % mixture of the compound in n-hexane, isohexane, cyclohexane, methylcyclohexane, or a combination thereof, forms a clear homogeneous solution at 25° C.

Catalyst compounds and catalyst systems may be soluble in aliphatic hydrocarbons. “Soluble” means less than 1 wt % solids remain after a period of stirring in the solvent and can be ascertained by filtering the solution and weighing remaining solids.

In some embodiments, a catalyst compound has a solubility of more than 10 mM (such as more than 20 mM, more than 50 mM, or more than 100 mM) at 25° C. (stirred 2 hours) in cyclohexane.

In some embodiments, a catalyst compound has a solubility of more than 10 mM (such as more than 20 mM, more than 50 mM, or more than 100 mM) at 25° C. (stirred 2 hours) in methylcyclohexane.

In some embodiments, a catalyst compound has a solubility of more than 10 mM (such as more than 20 mM, more than 50 mM, or more than 100 mM) at 25° C. (stirred 2 hours) in n-hexane.

In some embodiments, a catalyst compound has a solubility of more than 10 mM (such as more than 20 mM, more than 50 mM, or more than 100 mM) at 25° C. (stirred 2 hours) in methylcyclohexane and a solubility of more than 10 mM (such as more than 20 mM, more than 50 mM, or more than 100 mM) at 25° C. (stirred 2 hours) in n-hexane.

### Methods to Prepare the Catalyst Compounds

In some embodiments, the transition metal compounds may be prepared by addition of a silanolate, such as lithium tri-tert-butoxysilanolate to tungsten (VI) tetrachloride tert-butylamido. An example synthesis is shown below:

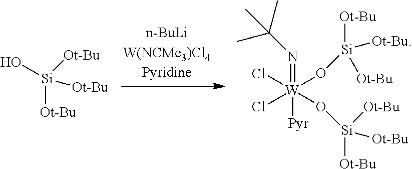

A silanolate may be prepared in-situ with any suitable base, such as tert-butyllithium, n-butyllithium, methyllithium, alkylmagnesiumchloride, dialkylmagnesium, alkali metal hydrides, or non-nucleophilic bases, such as tertiary amines or diazabicycloalkenes.

### Activators

The terms “cocatalyst” and “activator” are used interchangeably and are defined to be a compound which can activate one of the catalyst compounds described above by converting the neutral catalyst compound to a catalytically active catalyst compound cation.

After the complexes described above have been synthesized, catalyst systems may be formed by combining a compound with activators in any suitable manner including with a support material for use in slurry or gas phase polymerization. The catalyst systems may also be added to or generated in solution polymerization or bulk polymerization (in the monomer). Suitable catalyst systems may include a complex as described above and an activator such as alumoxane or a non-coordinating anion.

Activators may include, for example, organoaluminum compounds, organomagnesium compounds, or combinations thereof. In some embodiments, activators may be represented by formula (III):

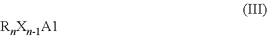

where: R is a hydrocarbyl or substituted hydrocarbyl; n is 1 to 3 (such as 1, 2 or 3); and X is a halogen.

In some embodiments, the activator is an alkylaluminum compound, such as diethylaluminum chloride, dibutylaluminum chloride, or tri-isobutylaluminum. In other embodiments, the activator is an organomagnesium compound, such as (trimethylsilyl)methylmagnesium chloride or (dimethylphenyl)methylmagnesium chloride.

### Optional Scavengers, Co-Activators, Chain Transfer Agents

In addition to activator compounds, scavengers or co-activators may be used. Compounds which may be utilized as scavengers or co-activators include, for example, Lewis acids, allylsilanes, or acyclic dienes. The allylsilane and acyclic diene compounds can also function as chain transfer agents.

A chain transfer agent may optionally be included in the polymerization to aid in controlling molecular weight and suppressing crosslinking reactions. Suitable chain transfer agents include olefin-substituted silanes, alpha-olefins and acyclic dienes. Examples of olefin-substituted silanes include, for example, tetraallyl silane, triallylmethyl silane, diallyldimethyl silane, allyltrimethyl silane. Suitable alpha-olefin chain transfer agents include ethylene, propylene, 1-butene, 1-pentene, 1-hexene, 1-octene, 1-decene, 1-docecene and substituted derivatives thereof. Suitable dienes include butadiene, 1,4-pentadiene, 1,5-hexadiene, 1,6-heptadiene, or 1,7-octadiene.

The chain transfer agent may have a strong effect on the polymer molecular weight, and, therefore, the amount of chain transfer agent that is used is selected at least in part based on the desired molecular weight of the polymer that is to be produced. From 0.001 to 0.1 moles of chain transfer agent may be used per mole of monomer(s).

### Methods for Forming Polyolefins:

Methods of the present disclosure include polymerizing olefin monomers to form a polyolefin having 50% or greater cis carbon-carbon double bonds. Polymerizing olefin monomers can be performed by introducing an olefin monomer with an olefin metathesis catalyst to a polymerization reactor under polymerization conditions. In at least one embodiment, polymerizing olefin monomers is a ring-opening metathesis polymerization (ROMP). In at least one aspect, an olefin metathesis catalyst can be immobilized on a silica support material before introducing the olefin metathesis catalyst and an olefin monomer to a polymerization reactor.

Methods of the present disclosure provide polyolefins having 50% or greater cis carbon-carbon double bonds, such as about 60% or greater, such as about 70% or greater, such as about 75% or greater, such as about 80% or greater, such as about 82% or greater, such as about 85% or greater. In at least one embodiment, a method of the present disclosure provides polyolefins having from about 80% to about 95% cis carbon-carbon double bonds, such as from about 85% to about 90% cis carbon-carbon double bonds.

Olefin monomers include cyclopentene, cyclooctene, cyclooctadiene, cyclopropene, cyclobutene, cyclohexene, methylcyclohexene, cycloheptene, norbornadiene, norbornene, cyclobutadiene, cyclohexadiene, cycloheptadiene, cyclooctatetraene, 1,5-cyclooctadiene, 1,5-dimethyl-1,5-cyclooctadiene, 1,2-dimethylcyclopent-1-ene, 1-methylcyclopent-1-ene, and dicyclopentadiene. In some embodiments, an olefin monomer is one or more of cyclopentene, cyclooctene, and cyclooctadiene. In at least one embodiment, an olefin monomer is cyclopentene. Olefin monomers can be unsubstituted or substituted at one or more carbon atoms with C₁-C₄₀ hydrocarbyl. One or more of the substituted olefin monomers can join together to form a saturated or unsaturated cyclic C₅-C₁₀ hydrocarbyl.

Polymerizing olefin monomers to form a polyolefin having 50% or greater cis carbon-carbon double bonds can be performed in an inert atmosphere by dissolving a catalytically effective amount of a catalyst in a solvent, and adding the olefin monomer, optionally dissolved in a solvent, to the catalyst solution to form a reaction solution. The reaction solution can be agitated (e.g., stirred). The progress of the polymerization occurring in the reaction solution can be monitored by, for example, nuclear magnetic resonance spectroscopy.

Solvents include any suitable organic solvent that is inert under the polymerization conditions. Solvents include aromatic hydrocarbons, chlorinated hydrocarbons, ethers, aliphatic hydrocarbons, alcohols, or mixtures thereof. In some embodiments, solvents include benzene, toluene, p-xylene, methylene chloride, 1,2-dichloroethane, dichlorobenzene, chlorobenzene, tetrahydrofuran, diethylether, pentane, methanol, or ethanol. In at least one embodiment, the solvent is one or more of toluene or 1,2-dichloroethane.

Alternatively, polymerizing olefin monomers is performed ‘neat’, e.g. without the presence of a solvent in a reaction mixture. In such embodiments, the reaction mixture includes only catalyst and olefin monomers, followed by subsequent polymerization of the olefin monomers in the reaction mixture. The olefin monomers can be a diluent for the catalyst and polymer product.

A temperature of the reaction mixture during polymerization can be maintained at any suitable temperature using a standard heating and/or cooling device. Reaction temperatures can be from about 0° C. to about 100° C., such as from about 25° C. to about 75° C., for example room temperature (e.g., about 23° C.). A reaction can be performed (e.g., stirring and/or heating of the reaction mixture) for any suitable amount of time, for example, until completion of the reaction. In at least one embodiment, a reaction time is from about 12 hours to about 48 hours, such as from about 15 hours to about 24 hours, for example about 18 hours.

The molar ratio of cycloolefin monomer to the catalyst can be selected based on the desired molecular weight of the polymer, desired polydispersity index (PDI), and the activity of the catalyst.

In some embodiments, the turnover number (TON) of a catalyst compound of Formula (I) in polymerizing the olefin monomers is from about 500 to about 50,000, such as from about 5,000 to about 45,000, such as from about 10,000 to about 30,000, such as from about 20,000 to about 25,000. Catalyst turnover number (TON) for production of the metathesis products of the present disclosure is defined as the [micromoles of metathesis product]/([micromoles of catalyst included in the reaction mixture].

In at least one embodiment, a reaction mixture includes a loading of a catalyst compound that is about 8 mol % or less, relative to an olefin. In some embodiments, the loading of a catalyst compound in a metathesis reaction is from about 0.0005 mol % to about 8 mol %, such as from about 0.001 mol % to about 4 mol %, such as from 0.005 mol % to about 2 mol %, such as from about 0.01 mol % to about 1.5 mol %, such as from about 0.02 mol % to about 1 mol %, such as from about 0.03 mol % to about 0.5 mol %.

In at least one embodiment, a method for forming a polyolefin having 50% or greater cis carbon-carbon double bonds includes introducing a first cyclic hydrocarbyl monomer and a catalyst compound to a polymerization reactor.

In at least one embodiment, the cyclic hydrocarbyl is a C₅ cycloolefin or a C₈ cycloolefin. The cyclic hydrocarbyl can be a C₅ cycloolefin that is cyclopentene. The cyclic hydrocarbyl can be a C₈ cycloolefin that is cyclooctene or cyclooctadiene.

In at least one embodiment, one catalyst compound is used, e.g., the catalyst compounds in a reaction mixture are not different. For purposes of the present disclosure, one catalyst compound is considered different from another if they differ by at least one atom. For example, chlorobenzene is different from benzene, which is different from dichlorobenzene. In at least one embodiment, two or more different catalysts are present in a reaction mixture. Two or more different catalyst compounds may include a first catalyst compound represented by Formula (I) and a second catalyst compound. When two different catalysts are used in one reaction mixture, the two catalysts may be chosen such that the two are compatible. A simple screening method such as by ¹H or ¹³C NMR, can be used to determine which catalysts are compatible.

The catalyst compounds may be used in any suitable ratio (A:B). The first catalyst compound may be (A) if the second catalyst compound is (B). Alternatively, the first catalyst compound may be (B) if the second catalyst compound is (A). Molar ratios of (A) to (B) (A:B) can be about 1:1000 to about 1000:1, such as about 1:100 to about 500:1, such as about 1:10 to about 200:1, such as about 1:1 to about 100:1, such as about 1:1 to about 75:1, such as about 5:1 to about 50:1. The ratio chosen will depend on the exact catalysts chosen and the desired end product (polymer). In at least one embodiment, when using the two catalyst compounds, useful mole percents, based upon the molecular weight of the catalyst compounds, are about 10% to about 99.9% of (A) to about 0.1% and about 90% of (B), such as about 25% to about 99% (A) to about 0.5% and about 50% (B), such as about 50% to about 99% (A) to about 1% and about 25% (B), such as about 75% to about 99% (A) to about 1% to about 10% (B).

One or more quench agents can be added to a polymerization reaction of the present disclosure to terminate olefin polymerization. The quench agent can form an end cap on one or both termini of the polymer formed from olefin polymerization. Quench agents include any suitable quenching agent. Quench agents can include an ether, vinylene carbonate, 3H-furanone, an amine, or benzaldehyde. Ethers may include ethyl vinyl ether, propyl vinyl ether, butyl vinyl ether, pentyl vinyl ether, or hexyl vinyl ether. Amines may include diazaphophepines, such as 2-phenoxy-1,3,4,7-tetrahydro-1,3,2-diazaphosphepine 2-oxide.

In certain embodiments, the catalyst compound utilized in a method of the present disclosure can be bound to or deposited on a solid catalyst support. The solid catalyst support will render the catalyst compound heterogeneous. The catalyst support can increase catalyst strength and attrition resistance. Catalyst supports include silicas, aluminas, silica-aluminas, aluminosilicates, including zeolites and other crystalline porous aluminosilicates, as well as titanias, zirconia, magnesium oxide, carbon, and cross-linked, reticular polymeric resins, such as functionalized cross-linked polystyrenes, e.g., chloromethyl-functionalized cross-linked polystyrenes. The catalyst compound can be deposited onto the support by suitable methods, including, for example, impregnation, ion-exchange, deposition-precipitation, and vapor deposition. Alternatively, the catalyst compound can be chemically bound to the support via one or more covalent chemical bonds, for example, the catalyst compound can be immobilized by one or more covalent bonds with one or more substituents of the ligands of the catalyst.

If a catalyst support is used, the catalyst compound can be loaded onto the catalyst support in any suitable amount. Typically, the catalyst compound is loaded onto the support in an amount that is greater than about 0.01 wt % of the Tungsten, such as greater than about 0.05 wt % of the Tungsten, based on the total weight of the catalyst compound plus support. Typically, the catalyst compound is loaded onto the support in an amount that is less than about 20 wt % of the Tungsten, such as less than about 10 wt % of the Tungsten, based on the total weight of the catalyst compound and support.

### Copolymerization

Methods of the present disclosure can further include contacting the catalyst compound with one or more second olefin monomers different than the first cyclic hydrocarbyl monomer to form a polyolefin copolymer or introducing the catalyst compound and one or more second olefin monomers different than the first cyclic hydrocarbyl monomer to a polymerization reactor to form a polyolefin copolymer.

The second olefin monomer can be a single cyclic or linear olefin, or a combination of cyclic and/or linear olefins, that is a mixture of two or more different olefins. The cycloolefins may be strained or unstrained, monocyclic, or polycyclic; and may optionally include heteroatoms and/or one or more substituents. Suitable cycloolefins include norbornene, norbornadiene, dicyclopentadiene, cyclopentene, cycloheptene, cyclooctene, cyclooctadiene, cyclododecene, 7-oxanorbornene, 7-oxanorbornadiene, cyclopropene, cyclobutene, cyclohexene, methylcyclohexene, cyclobutadiene, cyclohexadiene, cycloheptadiene, cyclooctatetraene, 1,5-dimethyl-1,5-cyclooctadiene, and substituted derivatives therefrom. A second olefin monomer can be substituted with one or more of hydroxyl, thiol, ketone, aldehyde, ester, ether, amine, imine, amide, nitro, carboxylic acid, disulfide, carbonate, isocyanate, carbodiimide, carboalkoxy, and halogen. In some embodiments, cycloolefins include cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, such as norbornene, norbornadiene, and dicyclopentadiene.

Second olefin monomers also include linear olefins. Any suitable linear mono-olefin may be used. A linear olefin can be an alpha olefin. The term “alpha olefin” includes an olefin where the carbon-carbon double bond occurs between the alpha and beta carbons of the carbon chain. Alpha olefins may be represented by the Formula: H₂C═CH—R*, where R* is hydrogen or a C₁ to C₃₀ hydrocarbyl; such as, a C₂ to C₂₀ hydrocarbyl; a C₃ to C₁₂ hydrocarbyl. In some embodiments, R* is methyl, ethyl, propyl, butyl, pentyl, heptyl, octyl, nonyl, decyl, undecyl, and dodecyl. In at least one embodiment, a second olefin monomer is one or more of 1-pentene, 1-hexene, 1-heptene, and 1-decene.

A linear olefin can be an internal olefin. The term “internal olefin” includes a compound having a double bond that is not between the alpha and beta carbons of the carbon chain. Internal olefins may be represented by the Formula: R*—HC═—CH—R*, where each R* is independently, a C₁ to C₃₀ hydrocarbyl; such as, a C₂ to C₂₀ hydrocarbyl; a C₂ to C₁₂ hydrocarbyl. In some embodiments, R* is methyl, ethyl, propyl, butyl, pentyl, and hexyl. In at least one embodiment, a second olefin monomer is one or more of hex-2-ene, hept-3-ene, and dec-5-ene.

A linear olefin can be substituted at various positions along the carbon chain with one or more substituents. In some embodiments, the one or more substituents are essentially inert with respect to the catalyst compound. Substituents include alkyl (such as, C₁₋₆ alkyl), cycloalkyl (such as, C₃₋₆ cycloalkyl), hydroxy, ether, keto, aldehyde, and halogen functionalities.

In some embodiments, linear olefins include ethylene, propylene, butene, pentene, hexene, octene, nonene, decene undecene, dodecene, and the isomers thereof (such as the isomers where the double bond is in the alpha position and isomers where the double bond is not in the alpha position). Alternatively, a linear olefin includes dec-5-ene, I-pentene, 1-decene, and 1-octene.

A second cyclic hydrocarbyl monomer can be added to a reaction mixture at the onset of a polymerization reaction which promotes random copolymer formation. Alternatively, the second cyclic hydrocarbyl monomer can be added to a reaction mixture after a polymerization of the first cyclic hydrocarbyl monomer has been performed. The sequential addition of a second cyclic hydrocarbyl monomer promotes block copolymer formation.

A polyolefin copolymer formed by a method of the present disclosure has about 50% or greater cis carbon-carbon double bonds, such as about 60% or greater cis carbon-carbon double bonds, such as about 70% or greater cis carbon-carbon double bonds, such as about 80% or greater cis carbon-carbon double bonds, such as about 90% or greater cis carbon-carbon double bonds, such as about 91% or greater cis carbon-carbon double bonds, such as about 92% or greater cis carbon-carbon double bonds, such as about 93% or greater cis carbon-carbon double bonds, such as about 94% or greater cis carbon-carbon double bonds, such as about 95% or greater cis carbon-carbon double bonds, such as about 96% or greater cis carbon-carbon double bonds, such as about 97% or greater cis carbon-carbon double bonds, such as about 98% or greater cis carbon-carbon double bonds, such as about 99% or greater cis carbon-carbon double bonds.

In at least one embodiment, a copolymer formed by methods of the present disclosure is a random or block poly-[cyclopentene]-[dicyclopentadiene]; poly-[cyclopentene]-[cyclooctene]; or poly-[cyclopentene]-[cyclooctadiene].

### Polymerization and Copolymerization in a Reactor

Methods of the present disclosure can be batch, semi-batch or continuous. The term continuous means a system that operates without interruption or cessation. For example, a continuous process to produce a polymer would be one where the reactants are continually introduced into one or more reactors and polymer product is continually withdrawn.

Useful reaction vessels include reactors (including continuous stirred tank reactors, batch reactors, reactive extruder, pipe, or pump. The processes may be conducted in glass lined, stainless steel, or similar type reaction equipment. Useful reaction vessels include reactors (including continuous stirred tank reactors, batch reactors, reactive extruder, pipe, or pump, continuous flow fixed bed reactors, slurry reactors, fluidized bed reactors, and catalytic distillation reactors). The reaction zone may be fitted with one or more internal and/or external heat exchanger(s) in order to control undue temperature fluctuations, or to prevent “runaway” reaction temperatures.

If the process is conducted in a continuous flow reactor, then the weight hourly space velocity, given in units of grams of feed material (such as a cycloolefin) per gram catalyst per hour (h⁻¹), will determine the relative quantities of feed material to catalyst employed, as well as the residence time in the reactor of the unsaturated starting compound. In a flow reactor, the weight hourly space velocity of the unsaturated feed material is typically greater than about 0.04 g feed material (such as a cycloolefin) per g catalyst per hour (h 1), such as, greater than about 0.1 h⁻¹. In a flow reactor, the weight hourly space velocity of the feed material is typically less than about 100 h⁻¹, such as, less than about 20 h⁻¹.

The quantity of metathesis catalyst that is employed in processes described is any suitable quantity that provides for an operable metathesis reaction. In some embodiments, the ratio of moles of feed material to moles of metathesis catalyst is typically greater than about 10:1, such as greater than about 100:1, greater than about 1000:1, greater than about 10,000:1, greater than about 25,000:1, greater than about 50,000:1, or greater than about 100,000:1. Alternately, the molar ratio of feed material to metathesis catalyst is typically less than about 10,000,000:1, such as less than about 1,000,000:1, or less than about 500,000:1.

The time that the reagents and catalyst are in a batch reactor can be any suitable duration, provided that the desired olefin metathesis products are obtained. Typically, the time in a reactor is greater than about 5 minutes, such as greater than about 10 minutes. Typically, the time in a reactor is less than about 25 hours, such as less than about 15 hours, or less than about 10 hours.

In some embodiments, the reactants (for example, metathesis catalyst; cycloolefins) are combined in a reaction vessel at a temperature of 20° C. to 300° C. (such as 20° C. to 200° C., 30° C. to 100° C., or 40° C. to 60° C.) and an alkene (such as ethylene) at a pressure of 0.1 to 1000 psi (0.7 kPa to 6.9 MPa) (such as 20 to 400 psi (0.14 MPa to 2.8 MPa), or 50 to 250 psi (0.34 MPa to 1.7 MPa)), for a residence time of 0.5 seconds to 48 hours (such as 0.25 to 5 hours, or 30 minutes to 2 hours).

In some embodiments, where the alkene is a gaseous olefin, the olefin pressure is greater than about 5 psig (34.5 kPa), such as greater than about 10 psig (68.9 kPa), or greater than about 45 psig (310 kPa). When a diluent is used with the gaseous alkene, the aforementioned pressure ranges may also be suitably employed as the total pressure of olefin and diluent. Likewise, when a liquid alkene is employed and the process is conducted under an inert gaseous atmosphere, then the aforementioned pressure ranges may be suitably employed for the inert gas pressure.

In some embodiments, from about 0.005 nmoles to about 500 nmoles, such as from about 0.1 to about 250 nmoles, or from about 1 to about 50 nmoles of the metathesis catalyst are charged to the reactor per 3 mmoles of feed material charged.

Typically, the conversion of feed material is greater than about 50 mole percent, such as greater than about 60 mole percent, or greater than about 70 mole percent. In some embodiments, the process is typically a solution process, although the process may be a bulk or high pressure process. Homogeneous processes are typical. (A homogeneous process is defined to be a process where at least 90 wt % of the product is soluble in the reaction media.) In some embodiments, the polymerization is a bulk homogeneous process. (A bulk process is defined to be a process where reactant concentration in all feeds to the reactor is 70 volume % or more.) Alternately no solvent or diluent is present or added in the reaction medium, (except for the small amounts used as the carrier for the catalyst or other additives, or amounts typically found with the reactants; e.g., propane in propylene).

### Polymers

The present disclosure also provides compositions of matter which can be produced by the methods described. Polymer structures of the present disclosure include tautomeric, geometric or stereoisomeric forms of the polymers. The present disclosure considers all such compounds, including cis- and trans-geometric isomers (Z- and E-geometric isomers), and mixtures of isomers thereof are embraced by the present disclosure.

Polymers of the present disclosure can have a glass transition temperature (Tg), as determined by the DSC procedure described below, from about −120° C. to about −20° C., such as from −115° C. to −50° C., −115° C. to −70° C., −115° C. to −90° C., −110° C. to −90° C.

Polymers of the present disclosure can have a melting temperature (Tm), as determined by the DSC procedure described below, from about −60° C. to about 0° C., such as from −40° C. to −25° C., −40° C. to −20° C., −35° C. to −25° C., −40° C. to −15° C., or −35° C. to −15° C.; or alternatively from −20° C. to −2° C., such as from −15° C. to −2° C., such as from −10° C. to −2° C., such as from −5° C. to −2° C.

The DSC procedures for determining glass transition temperature (Tg) and melting point (Tm) of polymers of the present disclosure include the following. The polymer is pressed at a temperature of from 200° C. to 230° C. in a heated press, and the resulting polymer sheet is hung, under ambient conditions (of 20-23.5° C.), in the air to cool. 6 to 10 mg of the polymer sheet is removed with a punch die. The 6 to 10 mg sample is annealed at room temperature (22° C.) for 80 to 100 hours. At the end of the time period, the sample is placed in a DSC (Perkin Elmer Pyris One Thermal Analysis System) and cooled at a rate of about 10° C./min to −30° C. to −50° C. and held for 10 minutes at −50° C. The sample is heated at 10° C./min to attain a final temperature of 200° C. The sample is kept at 200° C. for 5 minutes. Then a second cool-heat cycle is performed, using the same conditions described above. Events from both cycles, “first melt” and “second melt”, respectively, are recorded. Reference to melting point temperature and glass transition temperature refers to the first melt.

In at least one embodiment, a polyolefin formed by a method of the present disclosure has a melting point of from about −40° C. to about −20° C. A polyolefin formed by a method of the present disclosure can have a glass transition temperature from about −100° C. to about −115° C. In at least one embodiment, a polyolefin formed by a method of the present disclosure is a polycyclopentene having 50% or greater cis carbon-carbon double bonds, such as 60% or greater cis carbon-carbon double bonds, such as 70% or greater cis carbon-carbon double bonds, such as 80% or greater cis carbon-carbon double bonds, such as 90% or greater cis carbon-carbon double bonds, such as 91% or greater cis carbon-carbon double bonds, such as 92% or greater cis carbon-carbon double bonds, such as 93% or greater cis carbon-carbon double bonds, such as 93% or greater cis carbon-carbon double bonds, such as 94% or greater cis carbon-carbon double bonds, such as 95% or greater cis carbon-carbon double bonds, such as 96% or greater cis carbon-carbon double bonds, such as 97% or greater cis carbon-carbon double bonds, such as 98% or greater cis carbon-carbon double bonds, such as 99% or greater cis carbon-carbon double bonds.

In at least one embodiment, a polyolefin of the present disclosure is a polycyclopentene represented by Formula (II):

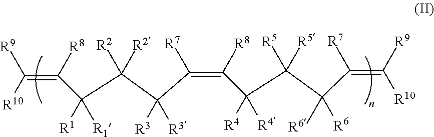

n is a positive integer. In at least one embodiment, n is from about 1 to about 50,000, such as from about 1,000 to about 10,000, such as from about 5,000 to about 8,000. Each of R¹, R^{1′}, R², R^{2′}, R³, R^{3′}, R⁴, R^{4′}, R⁵, R^{5′}, R⁶, R^{6′}, R⁷, R⁸ is independently hydrogen, C₁-C₄₀ hydrocarbyl, or R¹ and R³, R¹ and R², R⁴ and R⁵, or R⁴ and R⁶ join together to form a saturated or unsaturated cyclic C₅-C₁₀ hydrocarbyl. In at least one embodiment, each of R¹, R^{1′}, R², R^{2′}, R³, R^{3′}, R⁴, R^{4′}, R⁵, R^{5′}, R⁶ and R^{6′} is independently hydrogen or C₁-C₁₀ hydrocarbyl. In at least one embodiment, each of R¹, R^{1′}, R², R^{2′}, R³, R^{3′}, R⁴, R^{4′}, R⁵, R^{5′}, R⁶ and R^{6′} is hydrogen. In some embodiments, R⁷ and R⁸ are hydrogen. In some embodiments, R⁹ and R¹⁰ are independently hydrogen or an end cap. End caps include ether, amine, aryl, or carboxylic acid. Ether includes ethyl ether, propyl ether, butyl ether, pentyl ether, or hexyl ether. The polyolefin represented by Formula (II) can be formed by methods of the present disclosure.

In at least one embodiment, a polyolefin of the present disclosure is a polycyclooctene represented by Formula (III):

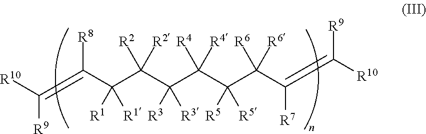

n is a positive integer. In at least one embodiment, n is from about 1 to about 50,000, such as from about 1,000 to about 10,000, such as from about 5,000 to about 8,000. Each of R¹, R^{1′}, R², R^{2′}, R³, R^{3′}, R⁴, R^{4′}, R⁵, R^{5′}, R⁶, R^{6′}, R⁷, and R⁸ is independently hydrogen, C₁-C₄₀ hydrocarbyl, or R¹ and R³, R¹ and R², R⁴ and R⁵, or R⁴ and R⁶ join together to form a saturated or unsaturated cyclic C₅-C₁₀ hydrocarbyl. In at least one embodiment, each of R¹, R^{1′}, R², R^{2′}, R³, R^{3′}, R⁴, R^{4′}, R⁵, R^{5′}, R⁶ and R^{6′} is independently hydrogen or C₁-C₁₀ hydrocarbyl. In at least one embodiment, each of R¹, R^{1′}, R², R^{2′}, R³, R^{3′}, R⁴, R^{4′}, R⁵, R^{5′}, R⁶ and R^{6′} is hydrogen. In some embodiments, R⁷ and R⁸ are hydrogen. In some embodiments, R⁹ and R¹⁰ are independently hydrogen or an end cap. End caps include ether, amine, aryl, or carboxylic acid. Ether includes ethyl ether, propyl ether, butyl ether, pentyl ether, or hexyl ether. The polyolefin represented by Formula (III) can be formed by methods of the present disclosure.

In at least one embodiment, a polyolefin of the present disclosure is a polycyclooctadiene represented by Formula (IV):

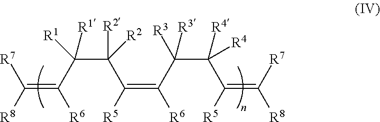

n is a positive integer. In at least one embodiment, n is from about 1 to about 50,000, such as from about 1,000 to about 10,000, such as from about 5,000 to about 8,000. Each of R¹, R^{1′}, R², R^{2′}, R³, R^{3′}, R⁴, R^{4′}, R⁵, and R⁶ is independently hydrogen, C₁-C₄₀ hydrocarbyl, or R¹ and R², or R³ and R⁴ join together to form a saturated or unsaturated cyclic C₅-C₁₀ hydrocarbyl. In at least one embodiment, each of R¹, R^{1′}, R², R^{2′}, R³, R^{3′}, R⁴, and R^{4′} is independently hydrogen or C₁-C₁₀ hydrocarbyl. In at least one embodiment, each of R¹, R^{1′}, R², R^{2′}, R³, R^{3′}, R⁴, and R^{4′} is hydrogen. In some embodiments, R⁵ and R⁶ are hydrogen. In some embodiments. R⁷ and R⁸ are independently hydrogen or an end cap. End caps include ether, amine, aryl, or carboxylic acid. Ether includes ethyl ether, propyl ether, butyl ether, pentyl ether, or hexyl ether. The polyolefin represented by Formula (IV) can be formed by methods of the present disclosure.

In at least one embodiment, a polyolefin of the present disclosure is a polydicyclopentadiene represented by Formulas (Va), (Vb), or (Vc):

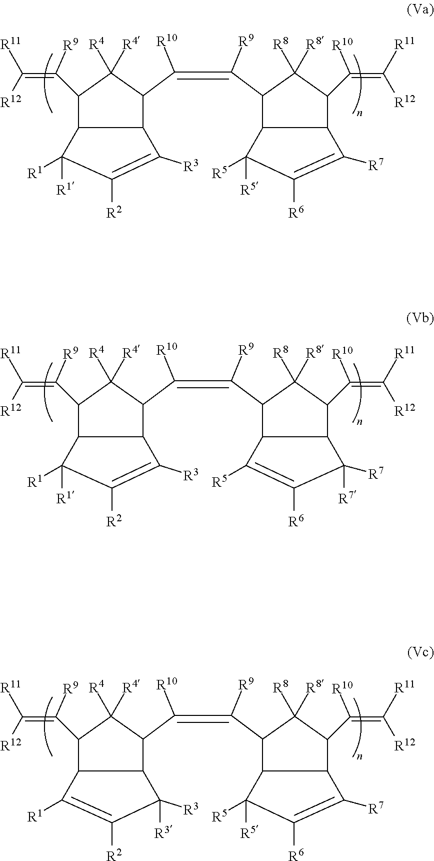

n is a positive integer. In at least one embodiment, n is from about 1 to about 50,000, such as from about 1,000 to about 10,000, such as from about 5,000 to about 8,000. Each of R¹, R^{1′}, R², R³, R^{3′}, R⁴, R^{4′}, R⁵, R^{5′}, R⁶, R⁷, R^{7′}, R⁸, R^{8′}, R⁹ and R¹⁰ is independently hydrogen, C₁-C₄₀ hydrocarbyl, or R¹ and R², R² and R³, R⁵ and R⁶, or R⁶ and R⁷ join together to form a saturated or unsaturated cyclic C₅-C₁p hydrocarbyl. In at least one embodiment, each of R¹, R^{1′}, R², R³, R^{3′}, R⁴, R^{4′}, R⁵, R^{5′}, R⁶, R⁷, R^{7′}, R⁸, and R^{8′} is independently hydrogen or C₁-C₁₀ hydrocarbyl. In at least one embodiment, each of R¹, R^{1′}, R², R³, R^{3′}, R⁴, R^{4′}, R⁵, R^{5′}, R⁶, R⁷, R^{7′}, R⁸, and R^{8′} is hydrogen. In some embodiments, R⁷ and R⁸ are hydrogen. In some embodiments, R¹¹ and R¹² are independently hydrogen or an end cap. End caps include ether, amine, aryl, or carboxylic acid. Ether includes ethyl ether, propyl ether, butyl ether, pentyl ether, or hexyl ether. The polyolefin represented by Formulas (Va), (Vb), and (VC) can be formed by methods of the present disclosure.

A polymer of the present disclosure can be a copolymer that is a random or block copolymer. In at least one embodiment, a copolymer is a poly-[cyclopentene]-[dicyclopentadiene]; poly-[cyclopentene]-[cyclooctene]; or poly-[cyclopentene]-[cyclooctadiene].

In at least one embodiment, a poly-[cyclopentene]-[dicyclopentadiene] is represented by Formula (VI):

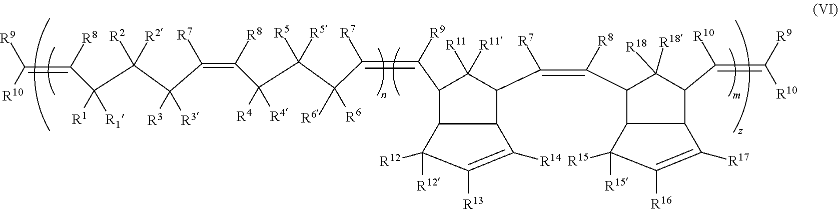

Each of n, m, and z is a positive integer. In at least one embodiment, n is from about 1 to about 25,000, such as from about 500 to about 5,000, such as from about 2,500 to about 4,000, m is from about 1 to about 25,000, such as from about 500 to about 5,000, such as from about 2,500 to about 4,000. z is from about 1 to about 5,000, such as from about 100 to about 3,000, such as from about 300 to about 1,000. Each of R¹, R^{1′}, R², R^{2′}, R³, R^{3′}, R⁴, R^{4′}, R⁵, R^{5′}, R⁶, R^{6′}, R⁷, R⁸, R¹¹, R^{11′}, R¹², R^{12′}, R¹³, R¹⁴, R¹⁵, R^{15′}, R¹⁶, R¹⁷, R¹⁸, and R^{18′} is independently hydrogen, C₁-C₄₀ hydrocarbyl, or R¹ and R², R² and R³, R⁴ and R⁵, R⁵ and R⁶, R¹² and R¹³, R¹³ and R¹⁴, R¹⁵ and R¹⁶, or R¹⁶ and R¹⁷ join together to form a saturated or unsaturated cyclic C₅-C₁₀ hydrocarbyl. In at least one embodiment, each of R¹, R^{1′}, R², R^{2′}, R³, R^{3′}, R⁴, R^{4′}, R⁵, R^{5′}, R⁶, R^{6′}, R⁷, R⁸, R¹¹, R^{11′}, R¹², R^{12′}, R¹³, R¹⁴, R¹⁵, R^{15′}, R¹⁶, R¹⁷, R¹⁸, and R¹⁸ is independently hydrogen or C₁-C₁₀ hydrocarbyl. In at least one embodiment, each of R¹, R^{1′}, R², R^{2′}, R³, R^{3′}, R⁴, R^{4′}, R⁵, R^{5′}, R⁶, R^{6′}, R⁷, R⁸, R^{8′}, R^{11′}, R¹², R^{12′}, R¹³, R¹⁴, R¹⁵, R^{15′}, R¹⁶, R¹⁷, R¹⁸, and R^{18′} is hydrogen. In some embodiments, R⁷ and R⁸ are hydrogen. In some embodiments, R⁹ and R¹⁰ are independently hydrogen or an end cap. End caps include ether, amine, aryl, or carboxylic acid. Ether includes ethyl ether, propyl ether, butyl ether, pentyl ether, or hexyl ether. The polyolefin represented by Formula (VI) can be formed by methods of the present disclosure.

In at least one embodiment, a poly-[cyclopentene]-[cyclooctene] is represented by Formula (VII):

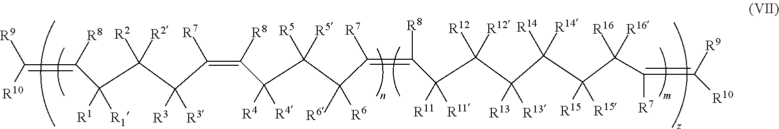

Each of n, in, and z is a positive integer. In at least one embodiment, n is from about 1 to about 25,000, such as from about 500 to about 5,000, such as from about 2,500 to about 4,000. m is from about 1 to about 25,000, such as from about 500 to about 5,000, such as from about 2,500 to about 4,000. z is from about 1 to about 5,000, such as from about 100 to about 3,000, such as from about 300 to about 1,000. Each of R¹, R^{1′}, R², R^{2′}, R³, R^{3′}, R⁴, R^{4′}, R⁵, R^{5′}, R⁶, R^{6′} R⁷, R⁸, R¹¹, R^{11′}, R¹², R^{12′}, R¹³, R^{13′}, R¹⁴, R^{14′}, R¹⁵, R^{15′}, R¹⁶, and R^{16′} is independently hydrogen, C₁-C₄₀ hydrocarbyl, or R¹ and R², R² and R³, R⁴ and R⁵, R⁵ and R⁶, R¹¹ and R¹², R¹² and R¹³, R¹³ and R¹⁴, R¹⁴ and R¹⁵, or R¹⁵ and R¹⁶ join together to form a saturated or unsaturated cyclic C₅-C₁₀ hydrocarbyl. In at least one embodiment, each of R¹, R^{1′}, R², R^{2′}, R³, R^{3′}, R⁴, R^{4′}, R⁵, R^{5′}, R⁶, R^{6′}, R⁷, R⁸, R¹¹, R^{11′}, R¹², R^{12′}, R¹³, R^{13′}, R¹⁴, R^{14′}, R¹⁵, R^{15′}, R¹⁶, and R^{16′} is independently hydrogen or C₁-C₁₀ hydrocarbyl. In at least one embodiment, each of R¹, R^{1′}, R², R^{2′}, R³, R^{3′}, R⁴, R^{4′}, R⁵, R^{5′}, R⁶, R^{6′}, R⁷, R⁸, R¹¹, R^{11′}, R¹², R^{12′}, R¹³, R^{13′}, R¹⁴, R^{14′}, R¹⁵, R^{15′}, R¹⁶, and R^{16′} is hydrogen. In some embodiments, R⁷ and R⁸ are hydrogen. In some embodiments, R⁹ and R¹⁰ are independently hydrogen or an end cap. End caps include ether, amine, aryl, or carboxylic acid. Ether includes ethyl ether, propyl ether, butyl ether, pentyl ether, or hexyl ether. The polyolefin represented by Formula (VII) can be formed by methods of the present disclosure.

In at least one embodiment, a poly-[cyclopentene]-[cyclooctadiene] is represented by Formula (VIII):

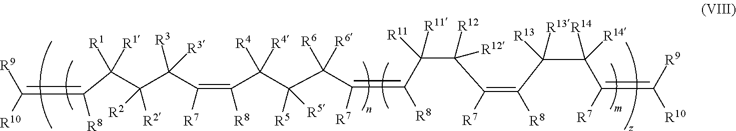

Each of n, m, and z is a positive integer. In at least one embodiment, n is from about 1 to about 25,000, such as from about 500 to about 5,000, such as from about 2,500 to about 4,000. m is from about 1 to about 25,000, such as from about 500 to about 5,000, such as from about 2,500 to about 4,000. z is from about 1 to about 5,000, such as from about 100 to about 3,000, such as from about 300 to about 1,000. Each of R¹, R^{1′}, R², R^{2′}, R³, R^{3′}, R⁴, R^{4′}, R⁵, R^{5′}, R⁶, R^{6′} R⁷, R⁸, R¹¹, R^{11′}, R¹², R^{12′} R¹³, R^{13′}, R¹⁴ and R^{14′} is independently hydrogen, C₁-C₄₀ hydrocarbyl, or R¹ and R², R² and R³, R⁴ and R⁵, R⁵ and R⁶, R¹¹ and R¹², or R¹³ and R¹⁴ join together to form a saturated or unsaturated cyclic C₅-C₁₀ hydrocarbyl. In at least one embodiment, each of R¹, R^{1′}, R², R^{2′}, R³, R^{3′}, R⁴, R^{4′}, R⁵, R^{5′}, R⁶, R^{6′}, R⁷, R⁸, R¹¹, R^{11′}, R¹², R^{12′}, R¹³, R^{13′}, R¹⁴, and R^{14′} is independently hydrogen or C₁-C₁₀ hydrocarbyl. In at least one embodiment, each of R¹, R^{1′}, R², R^{2′}, R³, R^{3′}, R⁴, R^{4′}, R⁵, R^{5′}, R⁶, R^{6′}, R⁷, R⁸, R¹¹, R^{11′}, R¹², R^{12′}, R¹³, R^{13′}, R¹⁴, and R^{14′} is hydrogen. In some embodiments, R⁷ and R⁸ are hydrogen. In some embodiments, R⁹ and R¹⁰ are independently hydrogen or an end cap. End caps include ether, amine, aryl, or carboxylic acid. Ether includes ethyl ether, propyl ether, butyl ether, pentyl ether, or hexyl ether. The polyolefin represented by Formula (VIII) can be formed by methods of the present disclosure.

The polymers represented by the Formulas (H), (III), (IV), (Va), (Vb), (Vc), (VI), (VII), and (VIII) may have 50% or greater cis carbon-carbon double bonds, such as 60% or greater cis carbon-carbon double bonds, such as 70% or greater cis carbon-carbon double bonds, such as 80% or greater cis carbon-carbon double bonds, such as 90% or greater cis carbon-carbon double bonds, such as 91% or greater cis carbon-carbon double bonds, such as 92% or greater cis carbon-carbon double bonds, such as 93% or greater cis carbon-carbon double bonds, such as 93% or greater cis carbon-carbon double bonds, such as 94% or greater cis carbon-carbon double bonds, such as 95% or greater cis carbon-carbon double bonds, such as 96% or greater cis carbon-carbon double bonds, such as 97% or greater cis carbon-carbon double bonds, such as 98% or greater cis carbon-carbon double bonds, such as 99% or greater cis carbon-carbon double bonds.

In at least one embodiment, a polymer as described has a unimodal or multimodal molecular weight distribution as determined by Gel Permeation Chromotography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versa).

In at least one embodiment, the polymer produced has a composition distribution breadth index (CDBI) of 50% or more, such as 60% or more, such as 70% or more. CDBI is a measure of the composition distribution of monomer within the polymer chains and is measured by the procedure described in PCT publication WO 1993/003093, published Feb. 18, 1993, specifically columns 7 and 8 as well as in Wild et al. (1982) J. Poly. Sci., Poly. Phys. Ed., v.20, p. 441 and U.S. Pat. No. 5,008,204, including that fractions having a weight average molecular weight (Mw) below 15,000 g/mol are ignored when determining CDBI.

### Blends

In at least one embodiment, a polymer of the present disclosure (such as polycyclopentene or polycyclooctene) is combined with one or more additional polymers prior to being formed into a film, molded part or other article. Other useful polymers include polyethylene, isotactic polypropylene, highly isotactic polypropylene, syndiotactic polypropylene, random copolymer of propylene and ethylene, and/or butene, and/or hexene, polybutene, ethylene vinyl acetate, LDPE, LLDPE, HDPE, ethylene vinyl acetate, ethylene methyl acrylate, copolymers of acrylic acid, polymethylmethacrylate or other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

In at least one embodiment, the polymer (such as polycyclopentene or polycyclooctene) is present in the above blends, at from 10 to 99 wt %, based upon the weight of the polymers in the blend, such as 20 to 95 wt %, such as at least 30 to 90 wt %, such as at least 40 to 90 wt %, such as at least 50 to 90 wt %, such as at least 60 to 90 wt %, such as at least 70 to 90 wt %.

The blends described above may be produced by mixing the polymers of the present disclosure with one or more polymers (as described above) can be mixed together prior to being put into an extruder or may be mixed in an extruder. The blends may be formed using suitable equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc.

In at least one embodiment, a method of blending the polymers may be to melt-blend the polymers in a batch mixer, such as a Banbury™ or Brabender™ mixer. Blending may include melt blending the first polymer and the second polymer in an extruder, such as a single-screw extruder or a twin-screw extruder. Extrusion technology for polymer blends is well known in the art, and is described in more detail in, for example, Plastics Extrusion Technology, F. Hensen, Ed. (Hanser, 1988), pp. 26-37, and in Polypropylene Handbook, E. P. Moore, Jr. Ed. (Hanser, 1996), pp. 304-348.

The first polymer and the second polymer may also be blended by a combination of methods, such as dry blending followed by melt blending in an extruder, or batch mixing of some components followed by melt blending with other components in an extruder. The first polymer and the second polymer may also be blended using a double-cone blender, ribbon blender, or other suitable blender, or in a Farrel Continuous Mixer (FCM™).

### Films

Specifically, the foregoing polymers, such as the foregoing polycyclopentenes, polycyclooctenes, or blends thereof, may be used in a variety of end-use applications. Such applications include, for example, mono- or multi-layer blown, extruded, and/or shrink films. These films may be formed by extrusion or coextrusion techniques, such as a blown bubble film processing technique, where the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and/or longitudinal directions to the same or different extents. The uniaxially orientation can be accomplished using typical cold drawing or hot drawing methods. Biaxial orientation can be accomplished using tenter frame equipment or a double bubble processes and may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. Typically the films are oriented in the Machine Direction (MD) at a ratio of up to 15, such as 5 to 7, and in the Transverse Direction (TD) at a ratio of up to 15, such as 7 to 9. However, in at least one embodiment the film is oriented to the same extent in both the MD and TD directions.

The films may vary in thickness depending on the intended application; however, films of a thickness from 1 to 50 μm are usually suitable. Films intended for packaging are usually from 10 to 50 μm thick. The thickness of the sealing layer is typically 0.2 to 50 μm. There may be a sealing layer on both the inner and outer surfaces of the film or the sealing layer may be present on only the inner or the outer surface.

In at least one embodiment, one or more layers may be modified by corona treatment, electron beam irradiation, gamma irradiation, flame treatment, or microwave. In at least one embodiment, one or both of the surface layers is modified by corona treatment.

### Some Embodiments of the Present Disclosure

Clause 1. A catalyst system represented by Formula (I):

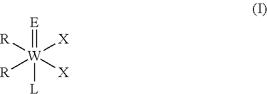

where:
   E is O, S, Se, Te, or NR″;
   R is independently a —OR′, —SR′, —OSi(OR′)₃, or —OSiR′₃, provided that when X is Cl, R is not —OR′;
   R′ is independently an unsubstituted hydrocarbyl or a halogen substituted hydrocarbyl;
   R″ is a hydrocarbyl or substituted hydrocarbyl, a heteroatom or a heteroatom-containing group (such as O, N, P, S);
   each X is a halogen, C₁ to C₁₀ hydrocarbyl, or a substituted C₁ to C₁₀ hydrocarbyl; and L is Lewis base.

Clause 2. The catalyst system of clause 1, wherein E is O.

Clause 3. The catalyst system of any of clauses 1 to 2, wherein X is a halogen.

Clause 4. The catalyst system of any of clauses 1 to 3, wherein R is —OSi(OR′)₃, or —OSiR′₃.

Clause 5. The catalyst system of any of clauses 1 to 4, wherein R′ is tert-butyl.

Clause 6. The catalyst system of any of clauses 1 to 5, wherein L is selected from substituted or unsubstituted pyridine.

Clause 7. The catalyst system of clause 1, wherein E is O, X is Cl, R is —OSi(OR′)₃, R′ is tert-butyl, and L is pyridine.

Clause 8. The catalyst system of clause 1, wherein E is NR″.

Clause 9. The catalyst system of clause 8, wherein X is C₁.

Clause 10. The catalyst system of any of clauses 8 to 9, wherein R is —OSi(OR′)₃, or —OSiR′₃.

Clause 11. The catalyst system of any of clauses 8 to 10, wherein R′ is tert-butyl.

Clause 12. The catalyst system of any of clauses 8 to 11, wherein R″ is tert-butyl or phenyl.

Clause 13. The catalyst system of any of clauses 8 to 12, wherein L is selected from substituted or unsubstituted pyridine.

Clause 14. The catalyst system of clause 1, wherein X is Cl, R is —OSi(OR′)₃, R′ is tert-butyl, R″ is tert-butyl, and L is pyridine.

Clause 15. The catalyst system of any of clauses 1 to 14, wherein the activator comprises an organoaluminum compound.

Clause 16. The catalyst system of clause 15, wherein the organoaluminum compound is selected from diethylaluminum chloride.

Clause 17. The catalyst system of any of clauses 1 to 16, further comprising a support material.

Clause 18. The catalyst system of clause 17, wherein the support material is selected from Al₂O₃, ZrO₂, SiO₂, SiO₂/Al₂O₃, SiO₂/TiO₂, silica clay, silicon oxide/clay, or mixtures thereof.

Clause 19. A process for the production of a polycycloolefin comprising: polymerizing a cycloolefin by introducing the cycloolefin with a catalyst system of any of Clauses 1 to 18 in at least one polymerization reactor at a reactor pressure of from 2 MPa to 200 MPa and a reactor temperature of from 10° C. to 250° C. to form a polycycloolefin.

Clause 20. The process of clause 19, wherein the cycloolefin is cyclopentene, cyclooctene, or a combination thereof.

Clause 21. The process of any of clauses 19 to 20, wherein the polycycloolefin has an Mw value of 200,000 g/mol or greater.

Clause 22. The process of clause 21, wherein the polycycloolefin has an Mw value of from 800,000 g/mol to 2,000,000 g/mol.

Clause 23. The process of any of clauses 19 to 22, wherein the polycycloolefin has an Mw/Mn value of 4 or less.

Clause 24. The process of clause 23, wherein the polycycloolefin has an Mw/Mn value of from 1 to 3.

Clause 25. The process of any of clauses 19 to 24, wherein the polycycloolefin has about 50% or greater cis-double bonds.

Clause 26. A catalyst compound represented by Formula (II):

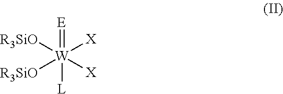

where:
   E is O, S, Te, Se, or NR″;
   each instance of R is independently a hydrocarbyl or substituted hydrocarbyl, a heteroatom or a heteroatom-containing group (such as O, N, P, S), provided that when E is O, R is not tert-butyl or tert-butoxy;
   R″ is a hydrocarbyl or substituted hydrocarbyl, a heteroatom or a heteroatom-containing group (such as O, N, P, S);
   each X is a halogen, C₁ to C₁₀ hydrocarbyl, or a substituted C₁ to C₁₀ hydrocarbyl; and
   L is Lewis base.

Clause 27. The catalyst compound of clause 26, wherein each instance of R is independently a tert-butyl, trifluoromethyl, 1,1-di(trifluoromethyl)ethyl, 1-methyl-1-(trifluoromethyl)ethyl, tert-butoxy, trifluoromethoxy, 1,1-di(trifluoromethyl)ethoxy, or 1-methyl-1-(trifluoromethyl)ethoxy.

Clause 28. The catalyst compound of any of clauses 26 to 27, wherein R″ is aryl or alkyl.

Clause 29. The catalyst compound of clause 28, wherein R″ is 2,6-disubstitutedphenyl.

Clause 30. The catalyst compound of clause 29, wherein R″ is 2,6-dimethylphenyl, 2,6-diisopropylphenyl, 2,6-dicyclopropylphenyl, or 2,6-di(trifluoromethyl)phenyl.

Clause 31. The catalyst compound of clause 28, wherein R″ tert-butyl.

Clause 32. The catalyst compound of any of clauses 26 to 31, wherein L is pyridine and X is Chlorine.

Clause 33. The catalyst compound of clause 26, wherein E is N, R is tert-butoxy, R″ is tert-butyl, X is chlorine, and L is pyridine.

### EXPERIMENTAL

### General Comments

Commercial cyclopentene was purified by passing through alumina column.

### Synthesis of WOCl₂(OSi(OtBu)₃)₂(Py) (Catalyst 1)

In a 20 mL vial, solid W(O)Cl₄ (0.191 g, 0.558 umol), and pyridine (0.049 g, 0.614 umol) was started to stir in 6 mL Et₂O. In a separate 20 mL scintillation vial, HOSi(OtBu)₃ (0.295 g, 1.00 umol) was dissolved in 4 mL Et₂O and cooled to −50° C. nBuLi (0.446 mL, 2.5 M in hexanes) was added using an autopipette. The solution was left at room temperature for 30 minutes. After 30 minutes, the colorless solution was added to in situ generated W(O)Cl₄(Py) solution using a glass pipette. The green solution was left at room temperature for 4 hours. After 4 hours, the solution was filtered through Celite and the solvent was evaporated in vacuo. The remaining solids were washed with 0.5 mL pentane and dried in vacuo to yield white flakes in 74% yield. The spectroscopic features of the compound are in agreement with reported data.

### Synthesis of tert-butylN═WCl₂(OSi(OtBu)₃)₂(Py) (Catalyst 2)

In a 20 mL vial, solid tBuN═W(O)Cl₄(Py) (0.150 g, 0.315 umol) was started to stir in mL Et₂O and cooled to −50° C. In a separate 20 mL scintillation vial, HOSi(OtBu)₃ (0.167 g, 0.630 umol) was dissolved in 5 mL Et₂O and cooled to −50° C. nBuLi (0.446 mL, 2.5 M in hexanes) was added using an autopipette. The solution was left at room temperature for 30 minutes. After 30 minutes, the colorless solution was cooled to −50° C. and added to the stirring tungsten solution using a glass pipette. The red solution was left at room temperature for 2 hours. After 2 hours, the solution was filtered through Celite and the solvent was evaporated in vacuo. The remaining solids were washed with 0.5 mL pentane and dried in vacuo to yield light yellow powder in 87% yield.

### ROMP of Cyclopentene Reaction

Catalyst (5 umol) was dissolved in neat cyclopentene (2000 equiv.) or a combination of cyclopentene and solvent. The aluminum or magnesium activator was added. After the visual confirmation of viscosity change, the polymer was quenched with 10 mL EtOH and dried under Argon. Results of the polymerizations are detailed in Table 1 below.

TABLE 1
Polymerization Data

| | | | | | | T |
|---|---|---|---|---|---|---|
| Example | Catalyst | Solvent | Activator | Eq. | C5 eq. | (° C.) |
| 1 | 1 | neat | Et₂AlCl | 30 | 2000 | −50 |
| 2 | 1 | neat | Et₂AlCl | 30 | 2000 | 25 |
| 3 | 1 | neat | Et₂AlCl | 30 | 2000 | 50 |
| 4 | 1 | neat | Et₂AlCl | 30 | 2000 | 70 |
| 5 | 1 | toluene | Et₂AlCl | 30 | 2000 | −50 |
| 6 | 1 | toluene | Et₂AlCl | 30 | 2000 | 25 |
| 7 | 1 | Iso-C₆ | Et₂AlCl | 30 | 2000 | −50 |
| 8 | 1 | Iso-C₆ | Et₂AlCl | 30 | 2000 | 25 |
| 9 | 1 | neat | Me₃SiCH₂MgCl | 2.5 | 2000 | 25 |
| 10 | 2 | neat | Me₃SiCH₂MgCl | 2.5 | 2000 | 25 |

TABLE 1
Polymerization Data

| Example | Mw (g/mol) | Mn (g/mol) | Mw/Mn | trans % |
|---|---|---|---|---|
| 1 | 212,478 | 87,983 | 2.4 | 70+ |
| 2 | 211,001 | 49,904 | 4.2 | 90+ |
| 3 | 333,733 | 141,981 | 2.4 | 80+ |
| 4 | 341,179 | 146,823 | 2.3 | 70+ |
| 5 | 121,761 | 59,968 | 2.0 | 50+ |
| 6 | 131,161 | 43,686 | 3.0 | 90+ |
| 7 | 149,072 | 54,845 | 2.7 | 80+ |
| 8 | 107,659 | 39,319 | 2.7 | 90+ |
| 9 | 230,938 | 120,542 | 1.9 | 10+ |
| 10 | 414,855 | 214,523 | 1.9 | 40+ |

Overall, catalyst compounds, catalyst systems, and processes of the present disclosure are soluble in aliphatic hydrocarbon and can produce polycycloolefins with high Mw values of 100,000 g/mol or greater, narrow PDI (e.g., about 4 or less), and high quantities of cis double bonds even at temperatures higher than room temperature. In some instances the catalyst systems of the present disclosure may produce a polycycloolefin with a trans:cis ration of 70:30 or less at temperatures of 25° C. or higher, such as a ratio of trans:cis of 77:23 at 70° C. In some cases catalyst compounds, catalyst systems, and processes of the present disclosure produce polycycloolefins with an Mn of about 200,000 g/mol or greater and an Mw of about 400,000 g/mol or greater.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described are incorporated by reference, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

1.-33. (canceled)

34. A catalyst compound represented by Formula (II): 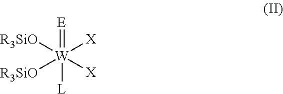
where:
E is O, S, Te, Se, or NR″;
each instance of R is independently a hydrocarbyl or substituted hydrocarbyl, a heteroatom or a heteroatom-containing group, provided that when E is O, R is not tert-butyl or tert-butoxy;
R″ is a hydrocarbyl or substituted hydrocarbyl, a heteroatom or a heteroatom-containing group;
X is a halogen, C₁ to C₁₀ hydrocarbyl, or a substituted C₁ to C₁₀ hydrocarbyl; and
L is a Lewis base.

35. The catalyst compound of claim 34, wherein each instance of R is independently a tert-butyl, trifluoromethyl, 1,1-di(trifluoromethyl)ethyl, 1-methyl-1-(trifluoromethyl)ethyl, tert-butoxy, trifluoromethoxy, 1,1-di(trifluoromethyl)ethoxy, or 1-methyl-1-(trifluoromethyl)ethoxy.

36. The catalyst compound of claim 34, wherein R″ is aryl, or alkyl.

37. The catalyst compound of claim 34, wherein R″ is 2,6-dimethylphenyl, 2,6-diisopropylphenyl, 2,6-dicyclopropylphenyl, or 2,6-di(trifluoromethyl)phenyl.

38. The catalyst compound of claim 34, wherein R″ is tert-butyl, L is pyridine, and X is chlorine.

39. A catalyst comprising:
an activator comprising Me₃SiCH₂MgCl; and
a catalyst compound represented by Formula (II) in claim 34.
